(19) United States
(12) Patent Application Publication
(10) Pub. No.: US 2021/0364808 A1
(43) Pub. Date: Nov. 25, 2021

(54) COMPACT LIGHT SOURCE

(71) Applicant: Facebook Technologies, LLC, Menlo Park, CA (US)

(72) Inventors: Alexander Koshelev, Redmond, WA (US); Giuseppe Calafiore, Redmond, WA (US); Maxwell Parsons, Seattle, WA (US)

(21) Appl. No.: 17/009,227

(22) Filed: Sep. 1, 2020

Related U.S. Application Data
(60) Provisional application No. 63/029,007, filed on May 22, 2020.

(51) Int. Cl. G02B 27/01; F21V 8/00; G02B 27/30; G02B 5/30

(52) U.S. Cl. CPC G02B 27/0176; G02B 6/0053; G02B 6/0031; G02B 6/0055; G02B 6/005; G02B 27/30; G02B 2027/0138; G02B 6/0056; G02B 27/0172; G02B 27/0179; G02B 2027/0178; G02B 2027/015; G02B 2027/0187; G02B 5/3058

(57) ABSTRACT

A thin-profile light source capable of providing polychromatic collimated light is disclosed. A waveguide propagates light along an optical path in the waveguide core. A top cladding of the waveguide is thinned so as to have a tail of the light mode propagating in the waveguide reach the end of the top cladding. A light extracting element is coupled to the top cladding. Light leaks out of the top cladding evanescently at an angle defined by a ratio of the refractive index of the light extracting element to an effective refractive index for the light mode propagating in the waveguide.

### REFERENCE TO RELATED APPLICATION

The present application claims priority from U.S. Provisional Application No. 63/029,007 entitled “Compact Light Source”, filed on May 22, 2020, and incorporated herein by reference in its entirety.

### TECHNICAL FIELD

The present disclosure relates to optical components, and in particular to light sources, optical collimators, and other optical components that emit light or redirect emitted light.

### BACKGROUND

Visual displays are used to provide information to viewer(s) including images, videos, data, etc. Visual displays are finding applications in diverse fields such as entertainment, education, training and biomedical science, to name just a few examples. Some visual displays, such as TV sets, may display images to several users, and some visual display systems may be intended for individual users. Head mounted displays (HMD), near-eye displays (NED), and the like are being used increasingly for displaying content to an individual user, such as virtual reality (VR) content, augmented reality (AR) content, mixed reality (MR) content, etc. The displayed VR/AR/MR content can be three-dimensional (3D) to enhance the experience and to match virtual objects to real objects observed by the user.

Compact display devices are desired for head-mounted displays. Because a display of HMD or NED is usually worn on the head of a user, a large, bulky, unbalanced, and/or heavy display device would be cumbersome and may be uncomfortable for the user to wear. Compact visual displays require compact sources of collimated light.

### BRIEF DESCRIPTION OF THE DRAWINGS

Exemplary embodiments will now be described in conjunction with the drawings, in which:

FIG. 1 is a side cross-sectional view of a light source of this disclosure;

FIG. 2A is a plan view of a light source of this disclosure;

FIG. 2B is a three-dimensional view of the light source of FIG. 2A without a light-extracting prism;

FIG. 2C is a three-dimensional view of the light source of FIG. 2A with the light-extracting prism;

FIG. 2D is a plot of a modulation transfer function (MTF) of the light source of FIG. 2A at different field angles;

FIG. 3 is a plan view of a light source including a photonic integrated circuit (PIC);

FIG. 4 is a side cross-sectional view of a transparent light source of this disclosure;

FIG. 5A is a side cross-sectional view of a holographic projector including the transparent light source of FIG. 4 and a spatial light modulator (SLM) configured spatially to modulate circularly polarized light;

FIG. 5B is a side cross-sectional view of a holographic projector including the transparent light source of FIG. 4 and an SLM configured to spatially modulate light at two orthogonal polarizations;

FIG. 5C is a schematic view of a projector including the transparent light source of FIG. 4 and a microelectromechanical system (MEMS) tiltable reflector;

FIG. 6 is a side cross-sectional view of a light source with a wavelength dispersion of illuminating light;

FIG. 7 is a side cross-sectional view of a light source with an increased wavelength dispersion of illuminating light; and

FIG. 8 is a view of an augmented reality (AR) display of this disclosure having a form factor of a pair of eyeglasses using a light source of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

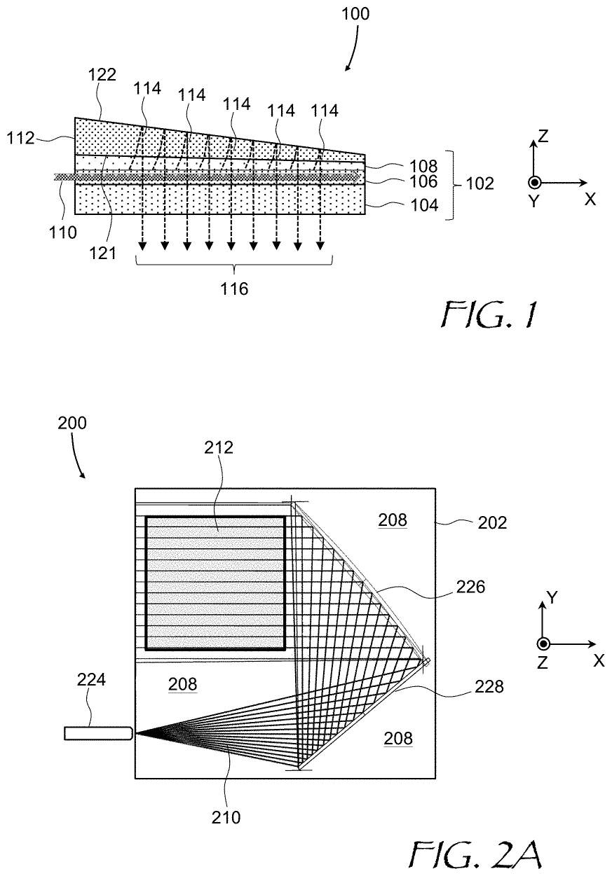

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1 through 7, similar reference numerals denote similar elements.

A typical light beam collimator includes an input port for a light beam, such as a tip of an optical fiber, coupled to a collimating element such as a lens. The output beam diameter is limited by a clear aperture of the collimating element. Thickness of such collimator is determined by an optical path length of the light beam emitted from the fiber tip, i.e. the focal length of the collimator plus thickness of the collimator. A 90 degrees turning mirror may be used if the length of the collimator is larger than its clear aperture diameter of the collimator. In the latter case, the thickness of the collimator is limited by the clear aperture diameter.

One approach to constructing thin collimators is to use a slab waveguide with a grating out-coupler. The grating out-coupler may be a diffraction grating written in the slab waveguide core. Such collimators may be as thin as the thickness of the slab waveguide used. However, the light output of a grating-based collimator is strongly wavelength dependent. For a typical laser diode with 1 nm bandwidth, this approach results in multiple beams with overall divergence of 10 arcmin, before taking into account thermal drifts. Such a divergence may be is unacceptable for many applications, e.g. visual display applications.

This disclosure describes a collimator that is free of the limitations of large thickness of bulk optic collimators, and the wavelength sensitivity of output beam angle/divergence of grating-based collimators. A light source/collimator of this disclosure includes a waveguide, typically a singlemode slab waveguide. The waveguide propagates light along an optical path in the waveguide core. A top cladding of the waveguide is thinned so as to have a tail of the light mode propagating in the waveguide reach the end of the top cladding. A light extracting element, e.g. a prism or a plate of glass having a refractive index higher than that of the effective refractive index of the waveguide, is coupled to the top cladding. Light leaks out of the top cladding evanescently, or in other words tunnels through the top cladding, at an angle defined by a ratio of the refractive index of the light extracting element to an effective refractive index of the waveguide. The latter depends on the refractive indices of the materials used, as well as on the geometry of the waveguide, e.g. core thickness. The leaked light is gathered and optionally redirected by the light extracting element, producing a collimated output beam with little or no dependence of the output beam angle on the wavelength. The beam may be focused or defocused (spread out) by the light extracting element, as required.

The light extracting element may be e.g. a thin reflective prism that redirects the out-coupled light back through the waveguide and out of the collimator. The top cladding may be wedged to provide a constant out-coupled optical power level along the path of propagation of light inside the waveguide, to offset reduced optical power levels with an increased out-coupling coefficient. The overall thickness of such a light source/collimator may be at least two times less than a diameter of the output light beam.

In accordance with the present disclosure, there is provided a light source comprising a waveguide and a light extractor. The waveguide includes a substrate, a slab core layer on the substrate, and a cladding layer on the slab core layer. The cladding layer has a thickness that varies in a direction of light propagation in the slab core layer. The light extractor is disposed on the cladding layer. The light extractor has a refractive index higher than an effective refractive index of a mode of propagation of light in the waveguide, for evanescent out-coupling of the light from the slab core layer into the light extractor. The waveguide may include a singlemode slab waveguide, and the thickness of the cladding may decrease in the direction of the light propagation. The thickness of the cladding layer may be e.g. between 0.1 micrometer and 5 micrometers.

In some embodiments, a thickness of the slab core layer under the cladding layer is selected to produce waveguide modal dispersion that at least partially offsets material dispersion of the refractive index of the light extractor, whereby a dependence of out-coupling angle of the light extracted by the light extractor on wavelength is lessened. In embodiments where waveguide comprises a photonic integrated circuit (PIC) comprising a waveguide array and a switching element for switching light between waveguides of the waveguide array, the waveguide may further include an integrated light source for providing light to the switching element.

In some embodiments, the light extractor comprises a first prism comprising first and second faces. The first face of the prism may be coupled to the cladding layer, and the second face of the first prism may include a first reflector for reflecting light out-coupled by the prism to propagate back through the waveguide. The reflector may have a finite radius of curvature. The reflector may include a diffractive optical element, and/or a metasurface, for shaping wavefront of the light reflected by the first reflector. The waveguide may include a second reflector in an optical path upstream of the light extractor. The second reflector may be curved for collimating impinging light in a plane of the waveguide. The waveguide may further include a third reflector in an optical path upstream of the second reflector, for redirecting light in-coupled by the in-coupler towards the second reflector. In embodiments where the reflector includes a reflective polarizer, the light source may further include a second prism coupled to the reflective polarizer.

In some embodiments, the light source further includes a tunable reflective device coupled to the waveguide opposite the light extractor to receive light reflected by the light extractor. The tunable reflective device may include at least one of a reflective spatial light modulator or a microelectromechanical system (MEMS) tiltable reflector. The light extractor may include a diffraction grating at a boundary between the cladding layer and the light extractor.

In accordance with the present disclosure, there is provided a collimator comprising a slab waveguide, e.g. a singlemode slab waveguide, coupled to an evanescent out-coupler for out-coupling light along its optical path in the slab waveguide so as to form a collimated output light beam propagating at an angle to a plane of the slab waveguide.

In accordance with the present disclosure, there is further provided a projector comprising a waveguide comprising a substrate, a slab core layer on the substrate, and a cladding layer on the slab core layer, the cladding layer having a thickness that varies in a direction of light propagation in the slab core layer. A light extractor is disposed on the cladding layer. The light extractor has a refractive index higher than an effective refractive index of a mode of propagation of light in the waveguide, for evanescent out-coupling of the light from the slab core layer into the light extractor. A tunable reflective device is optically coupled to the light extractor for receiving and redirecting the light out-coupled by the light extractor.

In some embodiments, the light extractor comprises a reflective polarizer for redirecting the light extracted from the waveguide to propagate through the waveguide and impinge onto the SLM, the extracted light having a first polarization. The tunable reflective device may be configured to reflect the redirected light back through the waveguide to impinge upon the reflective polarizer. The redirected light has a second polarization orthogonal to the first polarization, whereby the reflected spatially modulated light propagates through the reflective polarizer.

The tunable reflective device may include e.g. a spatial light modulator (SLM) for spatially modulating the light in at least one of amplitude or phase, and/or a microelectromechanical system (MEMS) tiltable reflector for reflecting the light at a variable angle. The light extractor may further include first and second prisms. The reflective polarizer may include a wiregrid polarizer sandwiched between diagonal faces of the first and second prisms. The SLM may be configured to provide at least one of: a spatially variant polarization state, or a spatially variant phase delay of the reflected spatially modulated light. When the reflected light has the spatially variant polarization state, the reflected light becomes amplitude modulated upon propagation through the reflective polarizer.

Specific examples of light sources and collimators of this disclosure will now be considered. Referring first to FIG. 1, a light source 100 includes a slab waveguide 102, e.g. a singlemode slab waveguide, having a substrate 104, a (slab) core layer 106 on the substrate 104, and a cladding layer 108 over the core layer 106. Thickness of the cladding layer 108 may change, i.e. may vary spatially, in a direction of light 110 propagation in the core layer 106. The light 110 propagates in X-direction in FIG. 1, and the thickness (measured in Z-direction) gradually decreases in going along the X-direction, i.e. left to right in FIG. 1.

A light extractor 112, e.g. a thin prism, is disposed on the top cladding layer 108. The light extractor 112 has a refractive index nₑₓₜ higher than an effective refractive index n_{eff} of a mode of propagation of the light 110 in the slab waveguide 102, and the cladding layer 108 is thin enough for evanescent out-coupling of the light 110 from the core layer 106 into the light extractor 112. By way of illustration, the thickness of the cladding layer 108 may be between 0.3 and 3 micrometers, or even between 0.1 micrometer and 5 micrometers in some embodiments.

In operation, the light 110 propagates in the core layer 106 in X-direction, as shown with a gray arrow. Portions 114 of the light 110 are out-coupled into the light extractor 110 as the light 110 propagates in the core layer 106. Angle θ (relative to the waveguide normal) at which the portions 114 are out-coupled depends only on the ratio of the effective refractive index n_{eff} of the waveguide mode to the refractive index nₑₓₜ of the extractor 112:

θ=a sin(n_{eff}/nₑₛₜ) (1)

Eq. (1) follows from the law of momentum conversion applied to light. The rate of light tunneling is controlled by the thickness of the cladding layer 108.

The thickness of the cladding layer 108 may decrease in the direction of the light 110 propagation (i.e. along X-axis), so as to offset depleting optical power level of the light 110 as portions 114 are evanescently out-coupled, and thereby increase spatial uniformity of output collimated light 116 out-coupled from the core layer 106 through the top cladding layer 108 and into the light extractor 112. The wedging may be obtained, for example, by low resolution greytone etching techniques. There may be an AR coating between the cladding layer 108 and the light extractor 112. The AR coating maybe applied to either top of the cladding 108, the bottom of the light extractor 112, or both, depending on the refractive index of the light extractor 112, the cladding 10, and the bonding material used.

In the embodiment shown, the light extractor 112 is a thin prism, e.g. thinner than 1 mm, having first 121 and second 122 faces forming a small acute angle. The second face 122 may include a reflector, e.g. metal or dielectric reflector, for reflecting the light portions 114 out-coupled by the prism to propagate back through the slab waveguide 102 at an angle close to normal angle. For example, for 0.95 mm tall light extractor 112, the angle may be about 26 degrees; it may be as low as within 15 degrees of the normal angle for some materials. The reflector at the second face 122 may be polarization-selective in some embodiments. In applications where a wider beam is needed, a thicker prism may be used. The prism's height may still remain less than one half of the beam diameter in that case. The second face 122 may be polished to a radius of curvature, so that the reflector has an optical (i.e. focusing or defocusing) power. It is noted that the term “prism”, as used herein, includes prisms with curved outer faces.

Table 1 below illustrates the dependence of angle θ of the out-coupled portions 114 on refractive indices of the materials used, and the resulting height of the prismatic light extractor 112 to achieve a 2 mm wide output beam.

TABLE 1

| Effective refractive | Refractive | | Height of |
|---|---|---|---|
| index n_{eff} of | index nₑₓₜ of | Angle θ, | the extractor |
| the waveguide 102 | the extractor 112 | degrees | 112, mm |
| 1.47 | 1.9 | 25.3 | 0.95 |
| 1.3 | 1.9 | 21.6 | 0.79 |
| 1.47 | 2.5 | 18 | 0.65 |
| 1.3 | 2.5 | 15.7 | 0.56 |

Since the output angle of the output light 116 depends only in the ratio n_{eff}/nₑₓₜ, the wavelength dispersion of the output angle is determined by dispersion of the materials used. Furthermore, while the dispersion of higher refractive index materials is typically higher than the dispersion of lower refractive index materials, the modal dispersion of the effective refractive index depends on the core layer 106 thickness and is typically higher than the dispersion of the material itself. Therefore, a thickness of the slab core layer 106 under the cladding layer 108 may be selected to produce waveguide modal dispersion that at least partially offsets material dispersion of the refractive index of the light extractor 112, for the purpose of reducing a dependence of out-coupling angle of the light 116 extracted by the light extractor 112 on wavelength.

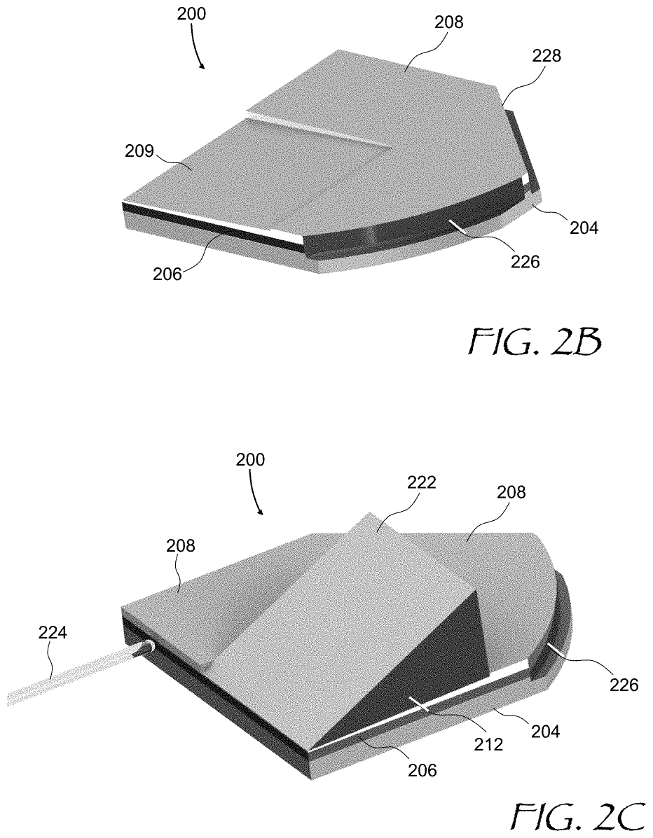

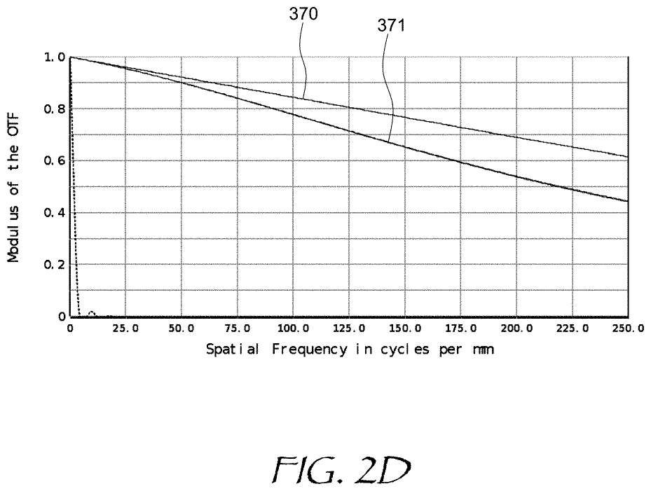

Referring to FIGS. 2A, 2B, and 2C, a light source 200 is similar to the light source 100 of FIG. 1, and includes similar elements. The light source 200 of FIGS. 2A-2C includes a slab waveguide 202, e.g. a singlemode slab waveguide, having a substrate 204 (FIGS. 2B and 2C), a core layer 206 on the substrate 204, and a cladding layer 208 having a portion 209. The light source 200 further includes a prismatic light extractor 212 (FIGS. 2A and 2C) for extracting light 210 in a similar manner as in the light source 100 of FIG. 1. The prismatic light extractor 212 has a top reflective surface 222. The light source 200 further includes an in-coupler 224 for in-coupling the light 210 into the slab waveguide 202. The in-coupler 224 may include e.g. a ball lens, a lensed or tapered fiber, a tapered waveguide, a metasurface structure, a Bragg grating, etc. A light source heterogeneously integrated on the slab waveguide 202 may also be used to provide the light 210.

In the embodiment shown, the slab waveguide 202 further includes a second reflector 226 in an optical path between the in-coupler 224 and the prismatic light extractor 212. The second reflector 226 may be curved for collimating light 210 in-coupled by the in-coupler 224 in a plane of the slab waveguide, i.e. XY plane (FIG. 2A). The waveguide 202 may also include a third reflector 228 in an optical path between the in-coupler 214 and the second reflector 226, for redirecting the light 210 in-coupled by the in-coupler 214 towards the second reflector 226, for compactness. Both second 226 and third 228 reflectors may be 1D reflectors that redirect and/or focus and/or defocus (spread or fan out) the light 210 in the plane of the slab waveguide 202, i.e. in XY plane, such that the light 210 remains guided in a direction perpendicular to the plane of the slab waveguide 202, i.e. in Z-direction. Such reflectors may be defined photolithographically, e.g. by deep etching. Reflective coatings may be deposited onto the corresponding sides of the slab waveguide 202 to provide a better reflectivity. Since ridge waveguides or gratings are not required, high resolution lithography is not needed to define the structures of the light source 200. Only a low-resolution etching of the side mirrors (i.e. reflectors 226, 228) is used, reducing overall costs.

In operation, the light 210 in-coupled by the in-coupler 224 into the core layer 206 of the slab waveguide 202, or provided internally by an integrated light source, diverges in XY plane while remaining guided in Z-direction by the slab waveguide 202 disposed in XY plane. The light 210 is redirected by the third reflector 228 to propagate towards the second reflector 226. The second reflector 226 has a curved reflecting surface for collimating the light 210 and redirecting the collimated light 210 towards the portion 209 of the cladding layer 208. The light 210 is out-coupled from the portion 209 of the cladding layer 208 by the prismatic light extractor 212, which redirects the light downwards in Z-direction to propagate back through the slab waveguide 202, and out of the light source 200, forming a collimated light beam propagating non-parallel (i.e. at an acute, straight, or obtuse angle) to a plane of the waveguide 202. The waveguide 202 and the prismatic light extractor 212 operate as a low-profile, i.e. low-thickness, light collimator. The light collimator operates by evanescently out-coupling of the light 201 from the slab waveguide core 206 along the propagation path of the light 210 in the slab waveguide core 206.

The height of the output collimated light beam, measured in Y-direction, is defined by the width of the second reflector 226 and the third reflector 228. The width of the output collimating light beam measured in X-direction is defined by the width of the portion 209 and the width of the prismatic light extractor 212. The width of the output light beam may exceed 2 mm at the total thickness of the light source in Z-direction not exceeding 1 mm. The height can exceed the 2 mm without increase in Z direction. Wider output collimated light beams may be produced by increasing the dimensions of the light source in XY plane. Furthermore, any of the top reflective surface 222, the second 226 and third 228 reflectors, or any other reflective and/or refractive surfaces in an optical path of the light 210 may be curved to focus or defocus an output light beam, as required. By way of non-limiting examples, the top reflective surface 222 may include a non-flat reflector, i.e. a reflector with a finite radius of curvature, a diffractive optical element such as a diffraction grating, and/or a metasurface including a stack of thin metal, dielectric, and/or semiconductor layers, for shaping the wavefront of the light 210 reflected from the top reflective surface 222.

Referring to FIG. 2D, a polychromatic diffraction MTF of the light source 200 includes a curve 370 for an on-axis optical beam corresponding to 0 degrees field angle, and a curve 371 for an off-axis optical beam, i.e. with the corresponding offset of the in-coupler 224 to create an output angle of 0.1 degrees. The curve 370 corresponds to the diffraction limit.

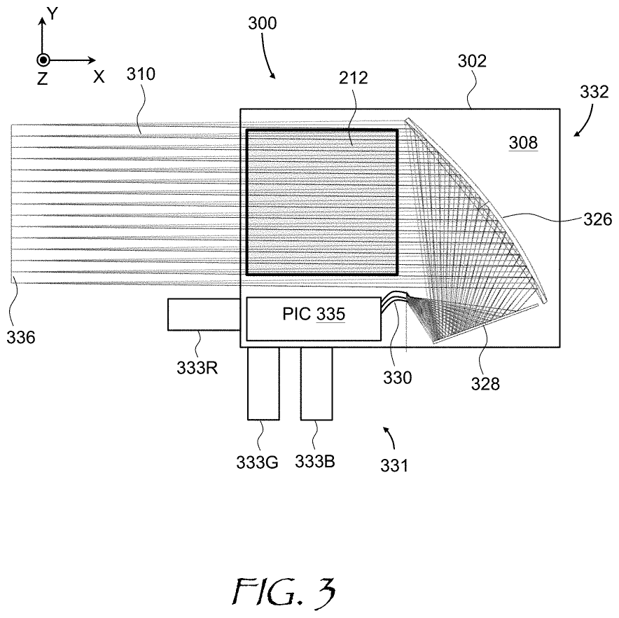

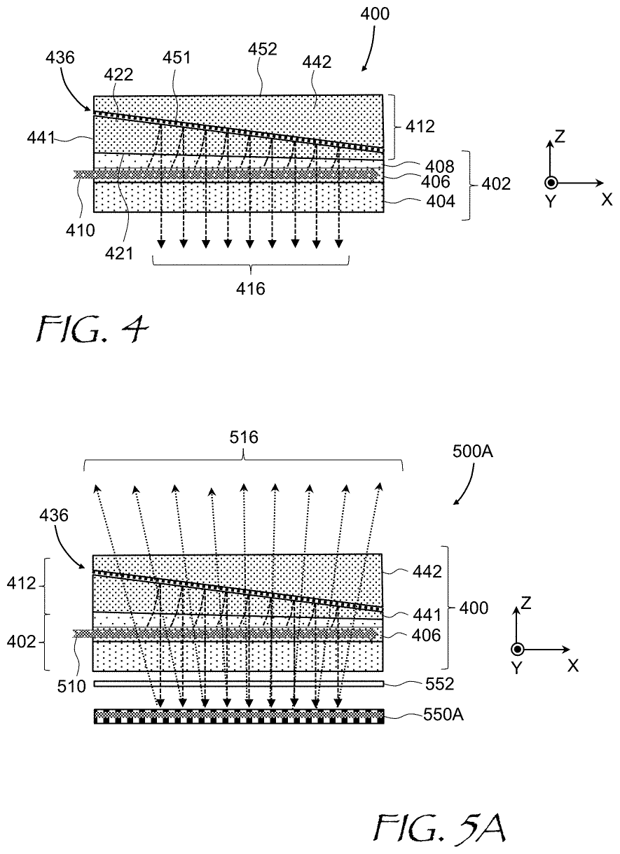

Turning to FIG. 3, a projector 300 is similar to the light source 200 of FIGS. 2A-2C. The projector 300 of FIG. 3 includes a waveguide 302 having linear waveguide portion 331 and a slab waveguide portion 332. Herein, the term “linear waveguide” denotes a waveguide that bounds the light propagation in two dimensions, like a light wire. A linear waveguide may be straight, curved, etc.; in other words, the term “linear” does not mean a straight waveguide section. One example of a linear waveguide is a ridge-type waveguide. The linear waveguide portion 331 includes a photonic integrated circuit (PIC) 335 having a plurality of linear waveguides, e.g. a linear waveguide array 330, or at least one such waveguide, optically coupled to the slab waveguide portion 332. The PIC 335 may receive light from red 333R, green 333G, and blue 333B light sources, e.g. red, green, and blue laser arrays. The function of the PIC 335 is to distribute light between waveguides of the waveguide array 330. To that end, the PIC 335 may include a switching element for switching light between different waveguides of the waveguide array 330. Waveguide tips of the waveguide array 330 act as point light sources injecting light into the slab waveguide portion 332.

The slab waveguide portion 332 has a slab core layer (not visible in FIG. 3) and a cladding layer 308 on the slab core layer. The cladding layer 308 may be thin enough to provide evanescent out-coupling of light, and may be wedged, as in the light source 200 of FIGS. 2A-2C. The light 310 is reflected by a third mirror 328 to a second curved mirror 326, which collimates the light 310 in plane of the waveguide 302. A light extractor 312 out-couples the light 310 from the light source 300. In FIG. 3, the light 310 is shown as propagating horizontally to illustrate that collimated light beams originated from the red 333R, green 333G, and blue 333B light sources fully intersect at a same plane 336. Essentially the light will be propagating vertically, out-coupled by the prismatic light extractor 212, as in the previous pictures. Out-coupling of the light by the prism creates a fold in the optical path. In FIG. 3, this path is unfolded and is still shown horizontally, for clarity. In some implementations, the light extractor 312 may redirect the light 310 to propagate vertically, i.e. along Z-axis in FIG. 3.

Waveguides of the linear waveguide array 330 are terminated at a focal plane (or, rather, focal curve) of the a second curved mirror 326. The termination angle of the waveguides determines the chief ray angle of the output and can be used to relay the pupil to where it is needed. The utilization of linear waveguides, e.g. ridge waveguides, enables one to put the mirror's focal point inside the slab waveguide portion 332, making the projector 300 even more compact. A single element mirror collimator has aberrations for non zero field angles. However, in a first approximation, these aberrations only shift the focal point's location. Since linear waveguide outputs do not have to be located along a straight line, even a simple collimator can be used for large FOV without significant aberrations.

Referring to FIG. 4, a transparent source 400 of collimated light is similar to the light source 100 of FIG. 1. The transparent source 400 of FIG. 4 includes a waveguide 402 having a substrate 404, a slab core layer 406 on the substrate 404, and a cladding layer 408 on the slab core layer 406. Thickness of the cladding layer 408 varies in a direction of light 410 propagation in the slab core layer 406, i.e. along the x-axis. A light extractor 412 includes a first prism 441 having first 421 and second 422 faces. The first prism 441 is disposed on the top cladding layer 408. The first prism 441 has a refractive index nₑₓₜ higher than an effective refractive index n_{eff} of a mode of propagation of the light 410 in the waveguide 402. The cladding layer 408 is thin enough for evanescent out-coupling of the light 410 from the slab core layer 406 into the light extractor 412.

In the embodiment shown, the light extractor 412 further includes a polarizer 436, e.g. a wire-grid reflective polarizer, coupled to the second face 422 of the first prism 441, and a second prism 442 coupled to the polarizer 436 and having first 451 and second 452 faces. The polarizer 436 is sandwiched between adjacent diagonal faces 422 and 451 of the first 441 and second 442 prisms. The first 441 and second 442 prisms have a same apex angle and are oriented in opposite directions to have parallel outer faces 421, 452. The first 441 and second 442 prisms can therefore transmit external light polarized orthogonally to the reflection polarization state of the reflective polarizer 436 substantially without changing the light direction, like a plano-parallel glass plate, enabling one to see through the transparent source 400.

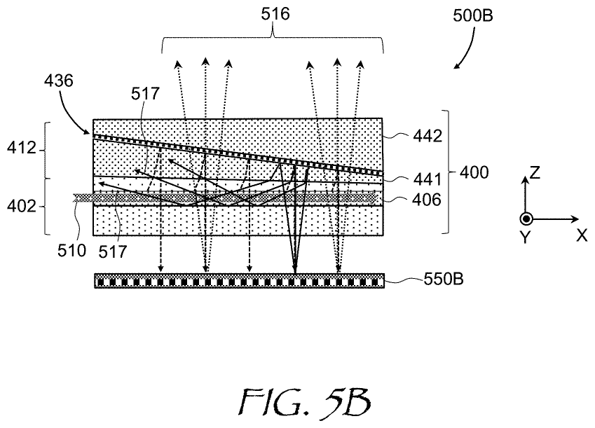

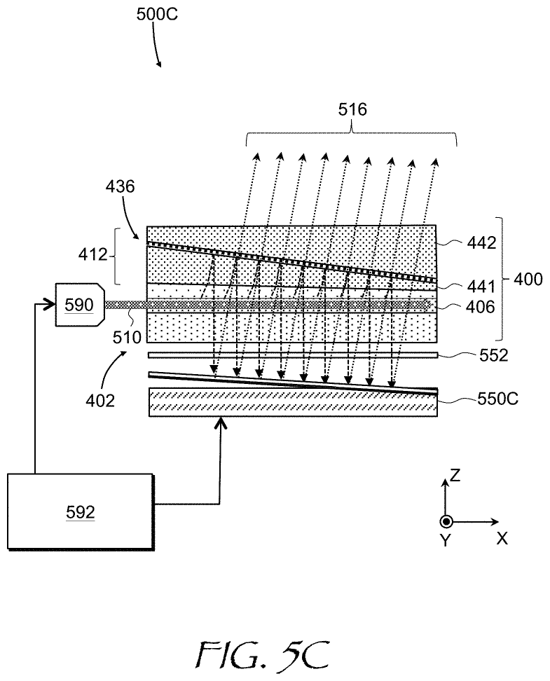

Turning to FIG. 5A, a projector 500A includes the transparent source 400 of FIG. 4 and a reflective spatial light modulator (SLM) 550A coupled to the waveguide 402 opposite the light extractor 412 via a quarter-wave waveplate (QWP) 552, to receive and redirect light reflected by the light extractor 412. In operation, light 510 propagates in the core layer 406 and is out-coupled into the first prism 441 along the optical path in X-direction. A component of the light 510 having a first polarization state, in this case a first linear polarization, is reflected by the polarizer 436 to propagate downwards towards the SLM 550A, propagates through the QWP 552 and becomes circularly polarized. The SLM 550A is configured for operation with circularly polarized light, providing amplitude and/or phase spatial modulation of the impinging circularly polarized light, without changing the polarization state of the light. The circularly polarized light 410 component is reflected by the SLM 550A at a plurality of directions defined by the SLM 550A, propagates again through the QWP 552 and becomes polarized at a second polarization state orthogonal to the first polarization state, in this case a second linear polarization perpendicular to the first linear polarization. Then, the light 510 propagates through the polarizer 436 and is out-coupled as an output beam 516 defined by the SLM 550A. The SLM 550A may include, for example, a microelectromechanical system (MEMS) array of tiltable reflectors, an array of variable reflectors, etc. The tiltable reflectors may be tiltable by a varying angle, in which case the spatial variation of reflected amplitude may be achieved by spatially variant tilting angle of individual MEMS reflectors. In some embodiments, the tiltable reflectors may be tiltable between two pre-defined angles, in which case the spatial variation of reflected amplitude may be achieved by oscillating each MEMS reflector between the two positions with a spatially variable duty cycle. In some embodiments, the SLM 550A may include a liquid crystal array that achieves a spatial variation of the reflected amplitude by spatially varying the polarization state of the reflected light beam.

Referring now to FIG. 5B, a projector 500B is similar to the projector 500A of FIG. 5A, and includes similar elements as the projector 500A. The projector 500B of FIG. 5B includes the transparent source 400 of FIG. 4 and a reflective SLM 550B coupled to the waveguide 402 opposite the light extractor 412 and configured to impart phase delays to light depending on the light polarization. The light 510 propagates in the core layer 406 and is out-coupled into the first prism 441 along the optical path, i.e. in X-direction. A linearly polarized component of the light 410 is reflected by the polarizer 436 to propagate downwards towards the SLM 550B. The SLM 550B is configured to provide spatially variant phase delays to polarized light, as follows. The SLM 550B may split the impinging light into two polarizations and independently delay each one of these two polarizations, to provide a reflected light beam that has spatially variant polarization state and/or a spatially variant phase delay. The light 410 is reflected by the SLM 550B with the spatially varying polarization and/or phase delay, and impinges onto the polarizer 436, which converts the spatial variation of polarization of the light 410 into a spatial variation of amplitude of an output light beam 516. Such a configuration enables to provide an output beam spatially modulated in both amplitude and phase. The spatially modulated output light beam 516 is out-coupled as an output beam 516 defined by the SLM 550. Light 517 reflected by the polarizer 436 is trapped inside the transparent source 400 by total internal reflection (TIR). The TIR condition is fulfilled automatically due to light reciprocity principle, and due to the light 510 having been guided by the waveguide 402 before being evanescently out-coupled from the waveguide 402. The SLM 550B may include, for example, a liquid crystal array such as a liquid crystal on silicon (LCoS) array with the individual pixel drivers and multiplexing circuitry implemented in the silicon substrate of the LCoS array. More generally, the term “SLM” as used herein means any device that spatially modulates a parameter of light such as amplitude, phase, polarization, etc.

Turning to FIG. 5C, a projector 500C is similar to the projector 500A of FIG. 5A. The projector 500C of FIG. 5C includes a light source 590 providing the light 510 of variable color and/or brightness to the transparent source 400 of FIG. 4, and a microelectromechanical system (MEMS) tiltable reflector 550C coupled to the waveguide 402 opposite the light extractor 412 via a quarter-wave waveplate (QWP) 552, to receive and redirect light reflected by the light extractor 412. In operation, light source generates the light 510, which is coupled to the core layer 406 of the waveguide 402. The light 510 propagates in the core layer 406 and is out-coupled into the first prism 441 along the optical path in X-direction. A component of the light 510 having a first polarization state, e.g. a first linear polarization, is reflected by the polarizer 436 to propagate downwards towards the MEMS tiltable reflector 550C, propagates through the QWP 552 and becomes circularly polarized. The MEMS tiltable reflector 550C reflects the light 510 at a variable angle. The reflected light 510 propagates again through the QWP 552 and becomes polarized at a second polarization state orthogonal to the first polarization state, in this case a second linear polarization perpendicular to the first linear polarization. Then, the light 510 propagates through the polarizer 436 and is out-coupled as an output beam 516 defined by the SLM 550A.

A controller 592 is operably coupled to the light source 590 and the MEMS tiltable reflector 550C. The controller 592 may be configured to operate the light source 590 in coordination with the MEMS tiltable reflector 550C to scan the output beam 516 about X and Y axes while sending commands to the light source 590 to adjust the brightness and/or color of the light 510, so as to render an image in angular domain. The MEMS reflector 550C may be tiltable about one or two axes. It is to be understood that a projector and/or a light source of this disclosure may include a tunable reflective device coupled to the transparent source 400 that redirects and/or spatially modulates the output beam. The tunable reflective device may include, for example, an SLM, a MEMS tiltable reflector, an array of MEMS reflectors, etc.

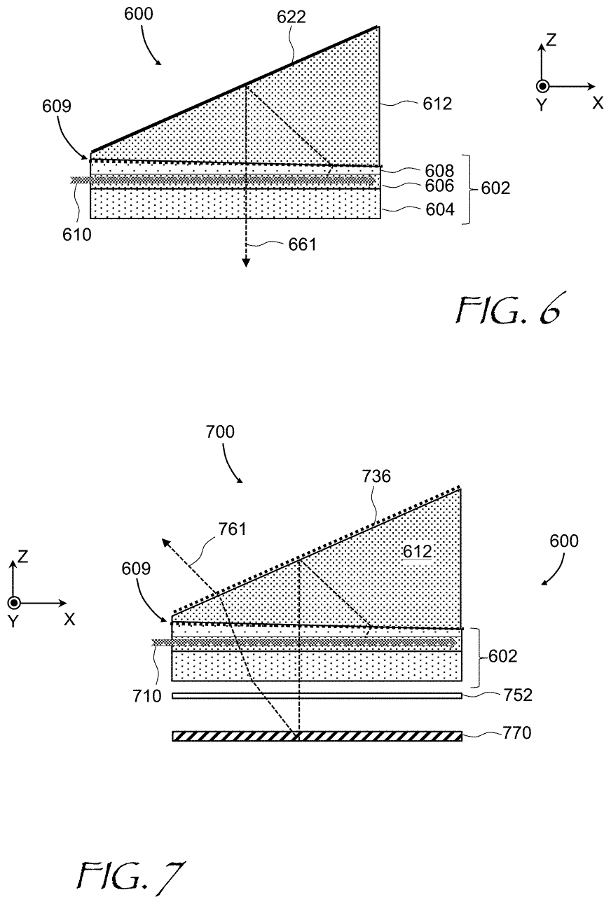

In applications where a pre-defined wavelength dispersion of the output beam angles is needed, the light sources may be modified by including wavelength-dispersive elements such as diffraction gratings, for example. Referring to FIG. 6, a wavelength-dispersive light source 600 is similar to the light source 100 of FIG. 1, and includes similar elements, including a waveguide 602 having a substrate 604, a slab core layer 606 on the substrate 604, and a cladding layer 608 on the slab core layer 606. Thickness of the cladding layer 608 changes, i.e. varies spatially, in a direction of light 610 propagation in the slab core layer 606. The light 610 propagates in X-direction in FIG. 6, and the thickness (Z-direction thickness) gradually decreases in going along the X-direction, i.e. left to right in FIG. 6.

The wavelength-dispersive light source 600 further includes a diffraction grating 609 formed on or within the cladding layer 608, and a light extracting prism 612 on the diffraction grating 609. In the embodiment shown, the diffraction grating 609 is disposed at a boundary between the cladding layer 608 and the light extracting prism 612. The prismatic light extractor may have its outer surface 622 mirrored to reflect light out-coupled from the waveguide 602. For operation in polarized light, the outer surface may include an optional reflective polarizer, e.g. a wire-grid polarizer. In some embodiments, the diffraction grating 609 is formed on or within the light extracting prism 612. The diffraction grating 609 may have a grating period selected such as to send a diffracted light beam 661 at an oblique angle, e.g. greater than 45 degrees w.r.t a normal vector of the grating. The oblique incidence and/or diffraction angle increases the magnitude of wavelength dispersion, enabling a greater angular separation of diffracted light beams at different wavelengths.

The wavelength dispersion may be further enhanced by providing a second diffraction grating in an optical path of an output light beam. Referring to FIG. 7, a wavelength-dispersive light source 700 includes the wavelength-dispersive light source 600 of FIG. 6 with a reflective polarizer 736 on an outer surface of the light extracting prism 612, and a second diffraction grating 770 coupled to the waveguide 602 opposite the light extractor 612 via a QWP 752 to receive and redirect light reflected by the light extractor 612. In operation, light 710 propagates in the waveguide 602 and is out-coupled into the light extracting prism 612 along the optical path in X-direction. A component of the light 610 having a first polarization state is reflected by the polarizer 436 to propagate downwards towards the second diffraction grating 770, propagates through the QWP 752, is diffracted by the second diffraction grating 770 at a wavelength-dependent angle of diffraction, propagates again through the QWP 752 and becomes polarized at a second polarization state orthogonal to the first polarization state. Then, the light 710 propagates through the polarizer 736 and is out-coupled as an output beam 761.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

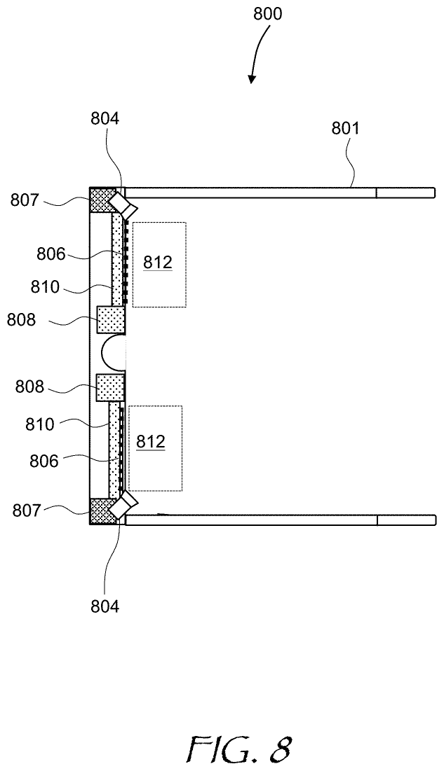

Referring to FIG. 8, an augmented reality (AR) near-eye display 800 includes a frame 801 having a form factor of a pair of eyeglasses. The frame 801 supports, for each eye, a projector 808, e.g. the projector 300 of FIG. 3, the projector 500A of FIG. 5A, and/or the projector 500B of FIG. 5B, including a light source described herein, e.g. the light source 100 of FIG. 1, the light source 200 of FIGS. 2A-2C, and/or the light source 400 of FIG. 4. The frame 801 also supports a waveguide 810 optically coupled to the projector 808. The AR near-eye display 800 may further include an eye-tracking camera 804, a plurality of illuminators 806, and an eye-tracking camera controller 807. The illuminators 806 may be supported by the waveguide 810 for illuminating an eyebox 812. The projector 808 provides a light beam to be projected into a user's eye. The waveguide 810 receives the light beam and expands the light beam over the eyebox 812.

The purpose of the eye-tracking cameras 804 is to determine position and/or orientation of both eyes of the user. Once the position and orientation of the user's eyes are known, a gaze convergence distance and direction may be determined. The imagery displayed by the projectors 808 may be adjusted dynamically to account for the user's gaze, for a better fidelity of immersion of the user into the displayed augmented reality scenery, and/or to provide specific functions of interaction with the augmented reality. In operation, the illuminators 806 illuminate the eyes at the corresponding eyeboxes 812, to enable the eye-tracking cameras to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with illuminating light, the latter may be made invisible to the user. For example, infrared light may be used to illuminate the eyeboxes 812.

The function of the eye-tracking camera controllers 807 is to process images obtained by the eye-tracking cameras 804 to determine, in real time, the eye gazing directions of both eyes of the user. In some embodiments, the image processing and eye position/orientation determination functions may be performed by a central controller, not shown, of the AR near-eye display 800. The central controller may also provide control signals to the projectors 808 to generate the images to be displayed to the user, depending on the determined eye positions, eye orientations, gaze directions, eyes vergence, etc.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A light source comprising:
a waveguide comprising:
a substrate;
a slab core layer on the substrate; and
a cladding layer on the slab core layer, the cladding layer having a thickness that varies in a direction of light propagation in the slab core layer; and
a light extractor on the cladding layer, the light extractor having a refractive index higher than an effective refractive index of a mode of propagation of light in the waveguide, for evanescent out-coupling of the light from the slab core layer into the light extractor.

2. The light source of claim 1, wherein the waveguide is a singlemode slab waveguide.

3. The light source of claim 1, wherein the thickness of the cladding layer decreases in the direction of the light propagation.

4. The light source of claim 1, wherein the thickness of the cladding layer is between 0.1 micrometer and 5 micrometers.

5. The light source of claim 1, wherein a thickness of the slab core layer under the cladding layer is selected to produce waveguide modal dispersion that at least partially offsets material dispersion of the refractive index of the light extractor, whereby a dependence of out-coupling angle of the light extracted by the light extractor on wavelength is lessened.

6. The light source of claim 1, wherein the waveguide comprises a photonic integrated circuit (PIC) comprising a waveguide array and a switching element for switching light between waveguides of the waveguide array.

7. The light source of claim 6, wherein the waveguide further comprises an integrated light source for providing light to the switching element.

8. The light source of claim 1, wherein the light extractor comprises a first prism comprising first and second faces, wherein the first face is coupled to the cladding layer, wherein the second face of the first prism comprises a first reflector for reflecting light out-coupled by the prism to propagate back through the waveguide.

9. The light source of claim 8, wherein the first reflector comprises at least one of a reflector with a finite radius of curvature, a diffractive optical element, or a metasurface, for shaping wavefront of the light reflected by the first reflector.

10. The light source of claim 8, wherein the waveguide comprises a second reflector in an optical path upstream of the light extractor, wherein the second reflector is curved for collimating impinging light in a plane of the waveguide.

11. The light source of claim 10, wherein the waveguide comprises a third reflector in an optical path upstream of the second reflector, for redirecting light in-coupled by the in-coupler towards the second reflector.

12. The light source of claim 8, wherein the reflector comprises a reflective polarizer, the light source further comprising a second prism coupled to the reflective polarizer.

13. The light source of claim 12, further comprising a tunable reflective device coupled to the waveguide opposite the light extractor to receive light reflected thereby, the tunable reflective device comprising at least one of a reflective spatial light modulator or a microelectromechanical system (MEMS) tiltable reflector.

14. The light source of claim 1, wherein the light extractor comprises a diffraction grating at a boundary between the cladding layer and the light extractor.

15. A collimator comprising a slab waveguide coupled to an evanescent out-coupler for out-coupling light along its optical path in the slab waveguide so as to form a collimated output light beam propagating at an angle to a plane of the slab waveguide.

16. The collimator of claim 15, wherein the slab waveguide is a singlemode slab waveguide.

17. A projector comprising:
a waveguide comprising a substrate, a slab core layer on the substrate, and a cladding layer on the slab core layer, the cladding layer having a thickness that varies in a direction of light propagation in the slab core layer;
a light extractor on the cladding layer, the light extractor having a refractive index higher than an effective refractive index of a mode of propagation of light in the waveguide, for evanescent out-coupling of the light from the slab core layer into the light extractor; and
a tunable reflective device optically coupled to the light extractor for receiving and redirecting the light out-coupled by the light extractor.

18. The projector of claim 17, wherein the light extractor comprises a reflective polarizer for redirecting the light extracted from the waveguide to propagate through the waveguide and impinge onto the SLM, the extracted light having a first polarization;
wherein the tunable reflective device is configured to reflect the redirected light back through the waveguide to impinge upon the reflective polarizer, the redirected light having a second polarization orthogonal to the first polarization, whereby the reflected spatially modulated light propagates through the reflective polarizer.

19. The projector of claim 17, wherein the tunable reflective device comprises at least one of: a spatial light modulator (SLM) for spatially modulating the light in at least one of amplitude or phase; or a microelectromechanical system (MEMS) tiltable reflector for reflecting the light at a variable angle.

20. The projector of claim 17, wherein the tunable reflective device comprises a spatial light modulator (SLM), wherein the light extractor further comprises first and second prisms, wherein the reflective polarizer comprises a wiregrid polarizer sandwiched between diagonal faces of the first and second prisms; and
wherein the SLM is configured to provide at least one of: a spatially variant polarization state, or a spatially variant phase delay of the reflected spatially modulated light, wherein, when the reflected light has the spatially variant polarization state, the reflected light becomes amplitude modulated upon propagation through the reflective polarizer.
